(19) United States
(12) Patent Application Publication
(10) Pub. No.: US 2024/0204192 A1
(43) Pub. Date: Jun. 20, 2024

(54) SILICON-CONTAINING ELECTRODES INCLUDING CROSS-LINKED POLYMERIC BINDERS AND METHODS FOR PREPARING THE SAME

(71) Applicant: GM GLOBAL TECHNOLOGY OPERATIONS LLC, Detroit, MI (US)

(72) Inventors: Dewen KONG, Shanghai (CN); Haijing LIU, Shanghai (CN); Mengyan HOU, Shanghai (CN); Si CHEN, Shanghai (CN); Zhixin XU, Shanghai (CN); Jun YANG, Shanghai (CN)

(73) Assignee: GM GLOBAL TECHNOLOGY OPERATIONS LLC, Detroit, MI (US)

(21) Appl. No.: 18/131,187

(22) Filed: Apr. 5, 2023

(30) Foreign Application Priority Data
Dec. 20, 2022 (CN) 202211638065.X

(51) Int. Cl. H01M 4/62; H01M 4/04; H01M 4/134; H01M 4/1395; H01M 4/38

(52) U.S. Cl. CPC H01M 4/622; H01M 4/0404; H01M 4/134; H01M 4/1395; H01M 4/386

(57) ABSTRACT

An electrode for an electrochemical cell includes a silicon-containing electroactive material that includes a plurality of silicon-containing electroactive material particles and a polymeric network that forms polymeric cages around each of the silicon-containing electroactive material particles of the plurality. The polymeric cages include polyacrylic acid (PAA), lithiated polyacrylic acid (PAALi), or a combination of polyacrylic acid (PAA) and lithiated polyacrylic acid (PAALi) covalently bonded with poly(2-hydroxyethyl acrylate) (PHEA). The polymeric network has a mass ratio of the polyacrylic acid (PAA), the lithiated polyacrylic acid (PAALi), or the combination of the polyacrylic acid (PAA) and the lithiated polyacrylic acid (PAALi) to the poly(2-hydroxyethyl acrylate) (PHEA) of greater than or equal to about 0.5 to less than or equal to about 10.

### CROSS-REFERENCE TO RELATED APPLICATIONS

This application claims the benefit and priority of Chinese Application No. 202211638065. X, filed Dec. 20, 2022. The entire disclosure of the above application is incorporated herein by reference.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12 V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator filled with a liquid or solid electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes so that a distinct separator is not required.

Many different materials may be used to create components for a lithium-ion battery. The negative electrode typically includes a lithium insertion material or an alloy host material. For example, typical electroactive materials for forming an anode include graphite and/or other forms of carbon, silicon and/or silicon oxide and/or other forms of silicon, and/or tin and/or tin alloys. Certain anode materials have particular advantages. While graphite having a theoretical specific capacity of 372 mAh·g⁻¹ is most widely used in lithium-ion batteries, anode materials with high specific capacity, for example high specific capacities ranging about 900 mAh·g⁻¹ to about 4,200 mAh·g⁻¹, are of growing interest. For example, silicon has the highest known theoretical capacity for lithium (e.g., about 4,200 mAh·g⁻¹), making it an appealing material for rechargeable lithium-ion batteries. Such materials, however, are often susceptible to huge volume expansion during lithiation and delithiation, which can lead to particle pulverization, loss of electrical contact, and unstable solid-electrolyte interface (SEI) formation, causing electrode collapse and capacity fading. Accordingly, it would be desirable to develop improved materials, and methods of making and using the same, that can address these challenges.

### SUMMARY

This section provides a general summary of the disclosure, and is not a comprehensive disclosure of its full scope or all of its features.

The present disclosure relates to silicon-containing electrodes including cross-linked polymeric binders, to electrochemical cells including the same, and to methods of making and using the same.

In various aspects, the present disclosure provides an electrode for an electrochemical cell that cycles lithium ions. The electrode may include a silicon-containing electroactive material and a polymeric network in contact with the silicon-containing electroactive material. The polymeric network may include polyacrylic acid (PAA) cross-linked with poly(2-hydroxyethyl acrylate) (PHEA).

In one aspect, the silicon-containing electroactive material may include Li_{y}SiOₓ, where 0<y<1 and 0<x<2.

In one aspect, the electrode may further include a carbonaceous electroactive material.

In one aspect, the electrode may include greater than or equal to about 80 wt. % to less than or equal to about 98 wt. % of the silicon-containing electroactive material and greater than or equal to about 85 wt. % to less than or equal to about 95 wt. % of the carbonaceous electroactive material.

In one aspect, the silicon-containing electroactive material may include a plurality of silicon-containing electroactive material particles, and the polymeric network may define a plurality of polymeric cages, where each polymeric cage of the plurality of polymeric cages at least partially surrounds one or more silicon-containing electroactive material particles of the plurality of silicon-containing electroactive material particles.

In one aspect, a mass ratio of the polyacrylic acid (PAA) to the poly(2-hydroxyethyl acrylate) (PHEA) may be greater than or equal to about 0.5 to less than or equal to about 10.

In one aspect, the electrode may include greater than or equal to about 1 wt. % to less than or equal to about 15 wt. % of the polymeric network.

In one aspect, the polyacrylic acid (PAA) may be lithiated polyacrylic acid (PAALi).

In one aspect, the electrode may further include greater than or equal to about 0.5 wt. % to less than or equal to about 15 wt. % of a conductive additive.

In one aspect, the polyacrylic acid (PAA) cross-linked with poly(2-hydroxyethyl acrylate) (PHEA) may define a first binder and the electrode may further include greater than 0 wt. % to less than or equal to about 10 wt. % of a second polymeric binder.

In one aspect, the second polymeric binder may be selected from the group consisting of: polyimide (PI), polyamic acid, polyamide, polysulfone, polyvinylidene difluoride (PVdF), polytetrafluoroethylene (PTFE), polyhexafluoropropene, polychlorotrifluoroethylene, ethylene propylene diene monomer (EPDM) rubber, carboxymethyl cellulose (CMC), nitrile butadiene rubber (NBR), styrene-butadiene rubber (SBR), sodium alginate, lithium alginate, polyacrylonitrile (PAn), and combinations thereof.

In various aspects, the present disclosure provides an electrode for an electrochemical cell that cycles lithium ions. The electrode may include a silicon-containing electroactive material that includes a plurality of silicon-containing electroactive material particles and a polymeric network that forms polymeric cages around each of the silicon-containing electroactive material particles of the plurality. The polymeric cages may include polyacrylic acid (PAA), lithiated polyacrylic acid (PAALi), or a combination of polyacrylic acid (PAA) and lithiated polyacrylic acid (PAALi) covalently bonded with poly(2-hydroxyethyl acrylate) (PHEA). The polymeric network may have a mass ratio of the polyacrylic acid (PAA), the lithiated polyacrylic acid (PAALi), or the combination of the polyacrylic acid (PAA) and the lithiated polyacrylic acid (PAALi) to the poly(2-hydroxyethyl acrylate) (PHEA) greater than or equal to about 0.5 to less than or equal to about 10.

In one aspect, the silicon-containing electroactive material may include Li_{y}SiOₓ, where 0<y<1 and 0<x<2.

In various aspects, the present disclosure provides a method for preparing a silicon-containing electrode. The method may include heating an electroactive material slurry disposed adjacent to one or more surfaces of a current collector to a temperature greater than or equal to about 120° C. to less than or equal to about 180° C. to form the silicon-containing electrode, where the electroactive material slurry includes a plurality of silicon-containing electroactive material particles and polymeric binders including polyacrylic acid (PAA) and poly(2-hydroxyethyl acrylate) (PHEA), and where after the heating, the silicon-containing electrode includes a polymeric network that contacts each of the silicon-containing electroactive material particles of the plurality of silicon-containing electroactive material particles, and the polymeric network includes the polyacrylic acid (PAA) cross-linked with the poly(2-hydroxyethyl acrylate) (PHEA).

In one aspect, the temperature may be held for a period greater than or equal to about 30 minutes to less than or equal to about 5 hours.

In one aspect, the temperature may be a first temperature and the method may further include preparing the poly(2-hydroxyethyl acrylate) (PHEA). The poly(2-hydroxyethyl acrylate) (PHEA) may be prepared by contacting 2-hydroxyethyl acrylate (HEA) and an initiator to form an admixture, heating the admixture to a second temperature greater than or equal to about 130° C. to less than or equal to about 180° C.; and precipitating poly(2-hydroxyethyl acrylate) from the admixture.

In one aspect, the method may further include disposing the electroactive material slurry on the one or more surfaces of the current collector.

In one aspect, the method may further include preparing the electroactive material slurry. The electroactive material slurry may be prepared by contacting the silicon-containing electroactive material, the polyacrylic acid (PAA), and the poly(2-hydroxyethyl acrylate) (PHEA).

In one aspect, the polyacrylic acid (PAA) may be lithiated polyacrylic acid (PAALi).

In one aspect, the silicon-containing electroactive material may include Li_{y}SiOₓ, where 0<y<1 and 0<x<2.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example electrochemical cell including a silicon-containing electrode including a cross-linked polymeric binder in accordance with various aspects of the present disclosure;

FIG. 2A is an illustration of the polyacrylic acid (PAA);

FIG. 2B is an illustration of poly(2-hydroxyethyl acrylate) (PHEA);

FIG. 2C is an illustration of a cross-linked polymeric binder including polyacrylic acid (PAA), a rigid polymer, cross-linked with poly(2-hydroxyethyl acrylate) (PHEA), a soft-chain polymer, in accordance with various aspects of the present disclosure;

FIG. 3 is a flowchart illustrating an example method for preparing a silicon-containing electrode including a cross-linked polymeric binder in accordance with various aspects of the present disclosure;

FIG. 4 is a graphical illustration demonstrating the capacity retention of an example silicon-containing electrode including a cross-linked polymeric binder in accordance with various aspects of the present disclosure; and

FIG. 5 is a graphical illustration demonstrating the capacity retention of an example silicon-containing electrode including a cross-linked polymeric binder in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology relates to electrochemical cells including silicon-containing electrodes and also to methods of forming and using the same. Such cells can be used in vehicle or automotive transportation applications (e.g., motorcycles, boats, tractors, buses, motorcycles, mobile homes, campers, and tanks). However, the present technology may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

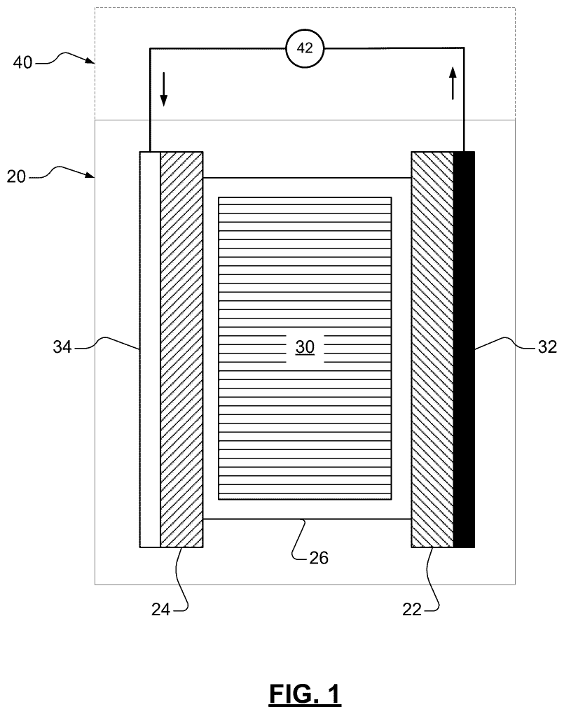

An exemplary and schematic illustration of an electrochemical cell (also referred to as a battery) 20 is shown in FIG. 1. The battery 20 includes a negative electrode 22 (e.g., anode), a positive electrode 24 (e.g., cathode), and a separator 26 disposed between the two electrodes 22, 24. The separator 26 provides electrical separation-prevents physical contact-between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and/or the positive electrode 24, so as to form a continuous electrolyte network. In certain variations, the separator 26 may be formed by a solid-state electrolyte or a semi-solid-state electrolyte (e.g., gel electrolyte). For example, the separator 26 may be defined by a plurality of solid-state electrolyte particles. In the instance of solid-state batteries and/or semi-solid-state batteries, the positive electrode 24 and/or the negative electrode 22 may include (additionally or alternatively) a plurality of solid-state electrolyte particles. The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode (also referred to as a negative electroactive material layer) 22. The first current collector 32 together with the negative electrode 22 may be referred to as a negative electrode assembly. Although not illustrated, the skilled artisan will appreciate that, in certain variations, negative electroactive material layers 22 may be disposed on one or more parallel sides of the first current collector 32. Similarly, the skilled artisan will appreciate that, in other variations, a negative electroactive material layer 22 may be disposed on a first side of the first current collector 32, and a positive electroactive material layer 24 may be disposed on a second side of the first current collector 32. In each instance, the first current collector 32 may be a metal foil, metal grid or screen, or expanded metal comprising copper, stainless steel, nickel, or any other appropriate electrically conductive material known to those of skill in the art.

A second current collector 34 (e.g., a positive current collector) may be positioned at or near the positive electrode (also referred to as a positive electroactive material layer) 24. The second current collector 34 together with the positive electrode 24 may be referred to as a positive electrode assembly. Although not illustrated, the skilled artisan will appreciate that, in certain variations, positive electroactive material layers 24 may be disposed on one or more parallel sides of the second current collector 34. Similarly, the skilled artisan will appreciate that, in other variations, a positive electroactive material layer 24 may be disposed on a first side of the second current collector 34, and a negative electroactive material layer 22 may be disposed on a second side of the second current collector 34. In each instance, the second electrode current collector 34 may be a metal foil, metal grid or screen, or expanded metal comprising aluminum or any other appropriate electrically conductive material known to those of skill in the art.

The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34). The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium-ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharged. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for the purpose of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, in certain aspects, the electrolyte 30 may be a non-aqueous liquid electrolyte solution (e.g., >1 M) that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC), vinylene carbonate (VC), and the like), linear carbonates (e.g., dimethyl carbonate (DMC), diethyl carbonate (DEC), ethylmethylcarbonate (EMC), and the like), aliphatic carboxylic esters (e.g., methyl formate, methyl acetate, methyl propionate, and the like), γ-lactones (e.g., γ-butyrolactone, γ-valerolactone, and the like), chain structure ethers (e.g., 1,2-dimethoxyethane, 1-2-diethoxyethane, ethoxymethoxyethane, and the like), cyclic ethers (e.g., tetrahydrofuran, 2-methyltetrahydrofuran, 1,3-dioxolane, and the like), sulfur compounds (e.g., sulfolane), and combinations thereof.

The separator 26 may be a porous separator. For example, in certain instances, the separator 26 may be a microporous polymeric separator including, for example, a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: Nomex, Aramid, and combinations thereof.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 micrometer (μm) to less than or equal to about 50 μm, and in certain instances, optionally greater than or equal to about 1 μm to less than or equal to about 20 μm.

In various aspects, the porous separator 26 and/or the electrolyte 30 disposed in the porous separator 26 as illustrated in FIG. 1 may be replaced with a solid-state electrolyte (“SSE”) and/or semi-solid-state electrolyte (e.g., gel) that functions as both an electrolyte and a separator. For example, the solid-state electrolyte and/or semi-solid-state electrolyte may be disposed between the positive electrode 24 and negative electrode 22. The solid-state electrolyte and/or semi-solid-state electrolyte facilitates transfer of lithium ions, while mechanically separating and providing electrical insulation between the negative and positive electrodes 22, 24. By way of non-limiting example, the solid-state electrolyte and/or semi-solid-state electrolyte may include a plurality of fillers, such as LiTi₂(PO₄)₃, LiGe₂(PO₄)₃, Li₇La₃Zr₂O₁₂, Li₃xLa_{2/3-x}TiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99} Ba_{0.005}ClO, or combinations thereof. The semi-solid-state electrolyte may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. In certain variations, the semi-solid or gel electrolyte may also be found in the positive electrode 24 and/or the negative electrode 22.

The negative electrode 22 is formed from a lithium host material that is capable of functioning as a negative terminal of a lithium-ion battery. In various aspects, the negative electrode 22 may be defined by a plurality of negative electroactive material particles. The negative electroactive material particles may be disposed in one or more layers so as to define the three-dimensional structure of the negative electrode 22. The electrolyte 30 may be introduced, for example after cell assembly, and contained within pores of the negative electrode 22 (i.e., within voids or spaces between the negative electroactive material particles). For example, in certain variations, the negative electrode 22 may include a plurality of solid-state electrolyte particles dispersed with the negative electroactive material particles. In each instance, the negative electrode 22 (including the one or more layers) may have a thickness greater than or equal to about 30 μm to less than or equal to about 500 μm, and in certain aspects, optionally greater than or equal to about 50 μm to less than or equal to about 100 μm.

In certain variations, the negative electroactive material particles may include silicon-containing (or silicon-based) electroactive materials. The silicon-containing electroactive materials may include silicon, lithium-silicon alloys, and/or other silicon-containing binary and/or ternary alloys. For example, in certain variations, the silicon-containing electroactive material may include elemental silicon (Si), various lithium silicide phases (LiₓSi_{y}, where 0<x<17 and 1<y<4), silicon nanograins embedded in a silicon oxide (SiOₓ, where 0<x<2) matrix, and/or lithium doped silicon oxide (Li_{y}SiOₓ, where 0<y<1 and 0<x<2 (LSO)). In certain variations, the silicon-containing electroactive materials may be provided as nano-particles, nano-fibers, nano-tubes, and/or micro-particles.

In certain variations, the negative electrode 22 may be a composite electrode including a combination of negative electroactive materials. For example, the negative electrode 22 may include a first negative electroactive material and a second negative electroactive material. A mass ratio of the first negative electroactive material to the second negative electroactive material may be greater than or equal to about 5:95 to less than or equal to about 95:5. In certain variations, the first negative electroactive material may be a volume-expanding material including, for example, silicon; and the second negative electroactive material may include a carbonaceous material (e.g., graphite, hard carbon, and/or soft carbon).

In each variation, the negative electroactive material may be intermingled with an electronically conductive material (i.e. conductive additive) that provides an electron conductive path. For example, the negative electrode 22 may include greater than or equal to about 70 wt. % to less than or equal to about 98 wt. %, and in certain aspects, optionally greater than or equal to about 85 wt. % to less than or equal to about 95 wt. %, of the negative electroactive material; and greater than or equal to about 0.5 wt. % to less than or equal to about 15 wt. %, and in certain aspects, optionally greater than or equal to about 0.5 wt. % to less than or equal to about 5 wt. %, of the conductive additive. Example conductive additives include, for example, carbon-based materials, powdered nickel or other metal particles, or conductive polymers. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples conductive polymers include polyaniline (PANi), polythiophene, polyacetylene, polypyrrole (PPy), and the like.

In various aspects, the negative electroactive material (and also the electronically conductive material) may be intermingled with a polymeric binder. For example, the negative electrode 22 may include greater than or equal to 1 wt. % to less than or equal 15 wt. %, and in certain aspects, optionally greater than or equal to about 2 wt. % to less than or equal to about 8 wt. %, of the polymeric binder. The polymeric binder may be a cross-linked polymeric binder including a rigid polymer (i.e., a polymer that is still and inflexible) like polyacrylic acid (PAA) cross-linked (e.g., covalently bonded) with a soft-chain polymer (i.e., a polymer that is flexible and elastic) like poly(2-hydroxyethyl acrylate) (PHEA). The polymeric binder may have a mass ratio of the polyacrylic acid (PAA) to the poly(2-hydroxyethyl acrylate) (PHEA) in the negative electrode 22 that is greater than or equal to about 0.5 to less than or equal to about 10.

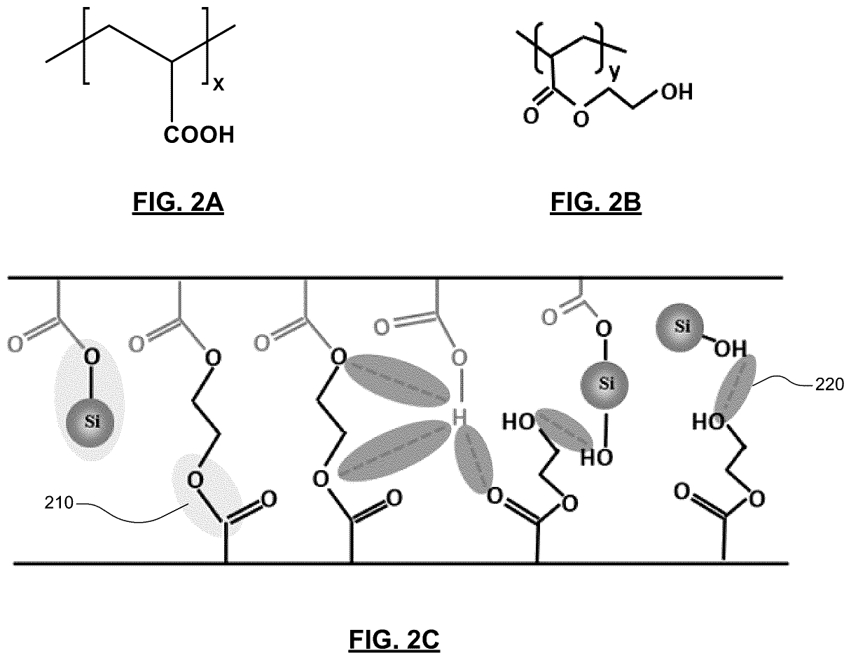

The cross-linked polymeric binder including the rigid polymer and the soft-chain polymers offers strong covalent bonds and dynamic hydrogen bonds so as to construct a flexible binder network within the negative electrode 22. For example, as illustrated in FIG. 2C, when the negative electroactive material includes lithium doped silicon oxide (Li_{y}SiOₓ, where 0<y<1 and 0<x<2 (LSO)), the rigid polymer includes polyacrylic acid (PAA) (as illustrated by way of example only in FIG. 2A), and the soft-chain polymer includes poly(2-hydroxyethyl acrylate) (PHEA) (as illustrated by way of example only in FIG. 2B), covalent bonds 210 may form between certain carboxyl groups (—COOH) of the polyacrylic acid (PAA) and certain carboxyl group (—COOH) of the poly(2-hydroxyethyl acrylate) (PHEA) to form the crosslinked structure, while hydrogen bonds 220 are co-existing between certain carboxyl groups (—COOH) of the polyacrylic acid (PAA) and certain carboxyl group (—COOH) of the poly(2-hydroxyethyl acrylate) (PHEA) and/or between certain carboxyl group (—COOH) of the poly(2-hydroxyethyl acrylate) (PHEA). In such instances, certain carboxyl groups (—COOH) of the polyacrylic acid (PAA) covalently bonds with silicon. For example, in certain variations, the hydrogen on the carboxyl (—COOH) group of the polyacrylic acid (PAA) may be partially or fully substituted by lithium ions (Li⁺) via reaction with a lithium-containing chemical (e.g., LiOH), as discussed below, to form PAALiₓH₍₁₋ₓ₎ (0≤x≤1). In other variations, the hydrogen on the carboxyl (—COOH) group of the polyacrylic acid (PAA) may be partially or fully substituted by sodium ions (Na⁺) via reaction with a sodium-containing chemical (e.g., NaOH), as discussed below, to form PAALiₓH₍₁₋ₓ₎ (0≤x≤1). In each instance, the flexible binder network defined by the covalent and hydrogen bonds may help to limit weakening adhesive force that may result from repeat volumetric changes during lithiation and delithiation thereby reducing or limiting pulverization and delamination, for example, by forming a polymeric cage that is in contact with (for example, in certain variations, at least partially surrounding) the lithium doped silicon oxide (Li_{y}SiOₓ, where 0<y<1 and 0<x<2 (LSO)).

With renewed reference to FIG. 2, in various aspects, the negative electroactive material (and also the electronically conductive material) may be intermingled with a first polymeric binder and a second polymeric binder. For example, the negative electrode 22 may include greater than or equal to about 1 wt. % to less than or equal to about 15 wt. %, and in certain aspects, optionally greater than or equal to about 0.5 wt. % to less than or equal to about 5 wt. %, of the first polymeric binder; and greater than or equal to about 0 wt. % to less than or equal to about 10 wt. %, and in certain aspects, optionally greater than or equal to about 0.1 wt. % to less than or equal to about 5 wt. %, of the second polymeric binder.

In certain variations, the first polymeric binder may be a cross-linked polymeric binder including a rigid polymer like polyacrylic acid (PAA) cross-linked with a soft-chain polymer like poly(2-hydroxyethyl acrylate) (PHEA), as described above. The second polymeric binder may be selected from the group consisting of: polyimide (PI), polyamic acid, polyamide, polysulfone, polyvinylidene difluoride (PVdF), polytetrafluoroethylene (PTFE), polyhexafluoropropene, polychlorotrifluoroethylene, ethylene propylene diene monomer (EPDM) rubber, carboxymethyl cellulose (CMC), nitrile butadiene rubber (NBR), styrene-butadiene rubber (SBR), sodium alginate, lithium alginate, polyacrylonitrile (PAn), and combinations thereof.

In each variation, the negative electrode 22 may have a porosity greater than or equal to about 20 vol. % to less than or equal to about 45 vol. %, and in certain aspects, optionally greater than or equal to about 30 vol. % to less than or equal to about 40 vol. %. The negative electrode 22 may have a capacity loading greater than or equal to about 3 mAh/cm² to less than or equal to about 6.05 mAh/cm², and in certain aspects, optionally greater than or equal to about 4 mAh/cm² to less than or equal to about 5.5 mAh/cm², for a one-sided coating at 0.1 capacity (C) at room temperature (i.e., greater than or equal to about 20° C. to less than or equal to about 25° C.). A pressing density of the negative electrode 22 may be greater than or equal to about 1.4 g/cm³ to less than or equal to about 1.8 g/cm³, and in certain aspects, optionally greater than or equal to about 1.5 g/cm³ to less than or equal to about 1.8 g/cm³. The negative electrode 22 may also have a moisture content of less than about 500 ppm, prior to the introduction of the electrolyte 30.

The positive electrode 24 is formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores of the positive electrode 24. In certain variations, the positive electrode 24 may include a plurality of solid-state electrolyte particles. In each instance, the positive electrode 24 may have an average thickness greater than or equal to about 1 μm to less than or equal to about 500 μm, and in certain aspects, optionally greater than or equal to about 10 μm to less than or equal to about 200 μm.

In various aspects, the positive electroactive material includes a layered oxide represented by LiMeO₂, where Me is a transition metal, such as cobalt (Co), nickel (Ni), manganese (Mn), iron (Fe), aluminum (Al), vanadium (V), or combinations thereof. In other variations, the positive electroactive material includes an olivine-type oxide represented by LiMePO₄, where Me is a transition metal, such as cobalt (Co), nickel (Ni), manganese (Mn), iron (Fe), aluminum (Al), vanadium (V), or combinations thereof. In still other variations, the positive electroactive material includes a monoclinic-type oxide represented by Li₃Me₂(PO₄)₃, where Me is a transition metal, such as cobalt (Co), nickel (Ni), manganese (Mn), iron (Fe), aluminum (Al), vanadium (V), or combinations thereof. In still other variations, the positive electroactive material includes a spinel-type oxide represented by LiMe₂O₄, where Me is a transition metal, such as cobalt (Co), nickel (Ni), manganese (Mn), iron (Fe), aluminum (Al), vanadium (V), or combinations thereof. In still other variations, the positive electroactive material includes a tavorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof. In still further variations, the positive electrode 24 may be a composite electrode including a combination of positive electroactive materials. For example, the positive electrode 24 may include a first positive electroactive material and a second electroactive material. A mass ratio of the first positive electroactive material to the second positive electroactive material may be greater than or equal to about 5:95 to less than or equal to about 95:5. In certain variations, the first and second electroactive materials may be independently selected from one or more layered oxides, one or more olivine-type oxides, one or more monoclinic-type oxides, one or more spinel-type oxide, one or more tavorite, or combinations thereof.

In each variation, the positive electroactive material may be optionally intermingled (e.g., slurry casted) with an electronically conductive material (i.e., conductive additive) that provides an electron conductive path and/or a polymeric binder material that improves the structural integrity of the positive electrode 24. For example, the positive electrode 24 may include greater than or equal to about 70 wt. % to less than or equal to about 98 wt. %, and in certain aspects, optionally greater than or equal to about 80 wt. % to less than or equal to about 97 wt. %, of the positive electroactive material; greater than or equal to 0 wt. % to less than or equal to about 30 wt. %, and in certain aspects, optionally greater than or equal to about 0.5 wt. % to less than or equal to about 10 wt. %, of the electrically conducting material; and greater than or equal to 0 wt. % to less than or equal to about 20 wt. %, and in certain aspects, optionally greater than or equal to about 0.5 wt. % to less than or equal to about 10 wt. %, of the polymeric binder.

The conductive additive as included in the positive electrode 24 may be the same as or different from the conductive additive as included in the negative electrode 22. In certain variations, like the negative electrode 22, the binder material as included in the positive electrode 24 may be cross-linked polymeric binder including a rigid polymer like polyacrylic acid (PAA) cross-linked with a soft-chain polymer like poly(2-hydroxyethyl acrylate) (PHEA). In other variations, the binder material as included in the positive electrode 22 may be another polymeric binder selected from the group consisting of: polyimide (PI), polyamic acid, polyamide, polysulfone, polyvinylidene difluoride (PVdF), polytetrafluoroethylene (PTFE), polyhexafluoropropene, polychlorotrifluoroethylene, ethylene propylene diene monomer (EPDM) rubber, carboxymethyl cellulose (CMC), nitrile butadiene rubber (NBR), styrene-butadiene rubber (SBR), sodium alginate, lithium alginate, polyacrylonitrile (PAn), and combinations thereof.

In still other variations, the binder material included in the positive electrode 24 may include a first binder material and a second binder material. For example, the positive electrode 24 may include greater than or equal to about 0 wt. % to less than or equal to about 15 wt. %, and in certain aspects, optionally greater than or equal to about 0.5 wt. % to less than or equal to about 5 wt. %, of the first polymeric binder; and greater than or equal to about 0 wt. % to less than or equal to about 10 wt. %, and in certain aspects, optionally greater than or equal to about 0.5 wt. % to less than or equal to about 5 wt. %, of the second polymeric binder. The first binder material may be a cross-linked polymeric binder including a rigid polymer like polyacrylic acid (PAA) cross-linked with a soft-chain polymer like poly(2-hydroxyethyl acrylate) (PHEA). The second binder material may be selected from the group consisting of: polyimide (PI), polyamic acid, polyamide, polysulfone, polyvinylidene difluoride (PVdF), polytetrafluoroethylene (PTFE), polyhexafluoropropene, polychlorotrifluoroethylene, ethylene propylene diene monomer (EPDM) rubber, carboxymethyl cellulose (CMC), nitrile butadiene rubber (NBR), styrene-butadiene rubber (SBR), sodium alginate, lithium alginate, polyacrylonitrile (PAn), and combinations thereof.

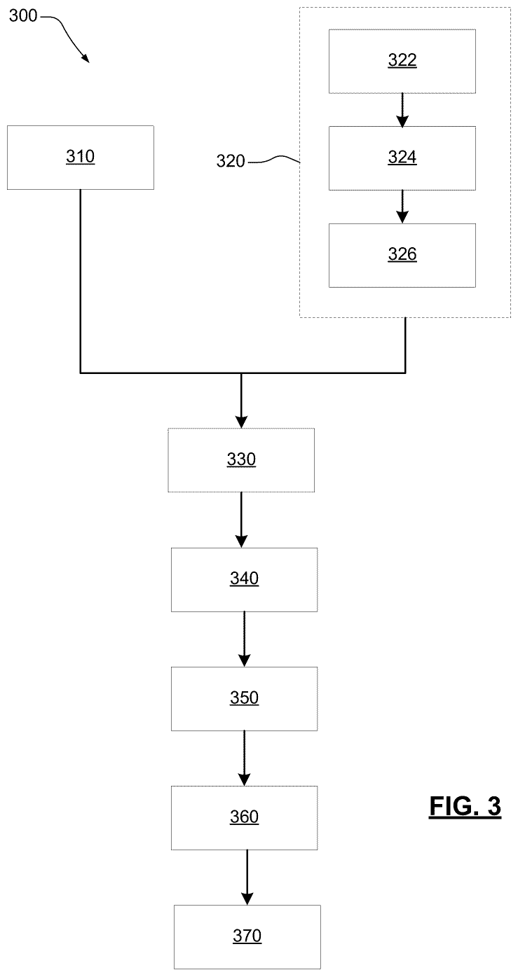

In various aspects, the present disclosure provides methods for forming silicon-containing electrodes including cross-linked polymeric binders, like the negative electrode 22 illustrated in FIG. 1. For example, as illustrated in FIG. 3, an example method 300 for forming a silicon-containing electrode including a cross-linked polymeric binder may include contacting 330 one or more polymeric materials with a negative electroactive material and a conductive additive to form a first admixture.

In each variation, the one or more polymeric materials may include a rigid polymer and a soft-chain polymer. For example, in certain variations, the one or more polymeric materials may include polyacrylic acid (PAA) a rigid polymer and poly(2-hydroxyethyl acrylate) (PHEA) a soft-chain polymer. The negative electroactive material may include lithium doped silicon oxide (Li_{y}SiOₓ, where 0<y<1 and 0<x<2 (LSO)). The conductive additive may include, for example, single-wall carbon nanotubes (SWCNT), SuperP (SP), carbon black (CB), and the like. In certain variations, the first admixture may greater than or equal to about 0.5 wt. % to less than or equal to about 5 wt. %, and in certain aspects, optionally greater than or equal to about 85 wt. % to less than or equal to about 95 wt. %, of the negative electroactive material; greater than or equal to about 1 wt. % to less than or equal to about 5 wt. %, and in certain aspects, optionally about 5 wt. %, of the conductive additive. A mass ratio of the rigid polymer to the soft-chain polymer in the first admixture may be greater than or equal to about 0.5 to less than or equal to about 10, and in certain aspects, optionally greater than or equal to about 0.5 to less than or equal to about 5.

In certain variations, the polyacrylic acid (PAA) may be lithiated polyacrylic acid (PAALi). In such instances, the method 300 may include preparing 310 the lithiated polyacrylic acid (PAALi). Preparing 310 the lithiated polyacrylic acid (PAALi) may include contacting polyacrylic acid (PAA) and a lithium-containing chemical, like lithium hydroxide (LiOH).

In certain variations, the method 300 may include preparing 320 the poly(2-hydroxyethyl acrylate) (PHEA). Preparing 320 the poly(2-hydroxyethyl acrylate) (PHEA) may include contacting (e.g., adding) 322 2-hydroxyethyl acrylate (HEA) with an initiator and a first solvent in a high temperature environment to form a second admixture. In certain variations, the initiator may include, for example, azobisisobutyronitrile (AIBN). The first solvent may include, for example, dimethylformamide (DMF).

In certain variations, the preparing 320 may also include contacting 324 (e.g., diluting) a second solvent to the second admixture to form a third admixture. The second solvent may include, for example, methanol.

In certain variations, the preparing 320 may also include precipitating 326 the poly(2-hydroxyethyl acrylate) (PHEA) by contacting (e.g., adding) a third solvent to the third admixture to precipitate the poly(2-hydroxyethyl acrylate) (PHEA). The third solvent may include, for example, diethyl ether (Et₂O).

In various aspects, the method 300 may further include contacting (e.g., adding) 340 the first admixture with a fourth solvent to form a coating slurry. The fourth solvent may include, for example, deionized water. The coating slurry may include greater than or equal to about 0.5 wt. % to less than or equal to about 10 wt. %, and in certain aspects, optionally greater than or equal to about 1 wt. % to less than or equal to about 5 wt. %, of the one or more polymeric materials; greater than or equal to about 80 wt. % to less than or equal to about 98 wt. %, and in certain aspects, optionally greater than or equal to about 90 wt. % to less than or equal to about 95 wt. %, of the negative electroactive material; greater than or equal to about 0.5 wt. % to less than or equal to about 10 wt. %, and in certain aspects, optionally greater than or equal to about 1 wt. % to less than or equal to about 5 wt. %, of the conductive additive. The coating slurry may have a solids content that is greater than or equal to about 39 wt. % to less than or equal to about 50 wt. %, and in certain aspects, optionally greater than or equal to about 40 wt. % to less than or equal to about 48 wt. %.

The method 300 may further includes disposing 350 (e.g., using a slot die) the coating slurry on one or more surfaces of a current collector to form one or more electroactive material precursor layers. The current collector may be a negative current collector like the first current collector 32 illustrated in FIG. 1.

The method 300 may further include heating 360 (e.g., using a heating tunnel) the one or more electroactive material precursor layers to remove the solvent(s) and form electroactive material layers including the cross-linked polymeric binder. The heat treatment 360 may include heating the one or more electroactive material layers to a second temperature greater than or equal to about 120° C. to less than or equal to about 180° C., and in certain aspects, optionally greater than or equal to about 140° C. to less than or equal to about 160° C. The second temperature may be held for a second period greater than or equal to about 5 minutes to less than or equal to about 5 hours, and in certain aspects, optionally greater than or equal to about 10 minutes to less than or equal to about 1 hour. The heat treatment 360 promotes (e.g., causes) the cross-linking of the rigid polymer (e.g., polyacrylic acid (PAA) and/or lithiated polyacrylic acid (PAALi)) and the soft-chain polymer (e.g., poly(2-hydroxyethyl acrylate) (PHEA)), while also removing residual solvents (e.g., water), such that the as formed electroactive material layers have a moisture content of less than about 500 ppm.

In certain variations, the method 300 may further include calendaring 370 the one or more as-formed electroactive material layers so as to vary the thickness of the electroactive material layers.

Certain features of the current technology are further illustrated in the following non-limiting examples.

### Example 1

Example batteries and battery cells may be prepared in accordance with various aspects of the present disclosure. For example, an example electrode 410 may include cross-linked polymer binder including lithiated polyacrylic acid (PAALi) and poly(2-hydroxyethyl acrylate) (PHEA) in accordance with various aspects of the present disclosure. The example electrode 410 also includes a silicon-containing electroactive material including lithium doped silicon oxide (Li_{y}SiOₓ, where 0<y<1 and 0<x<2 (LSO). The example electrode 410 may also include one or more conductive additives. For example, the example electrode 410 may include a first conductive additive and a second conductive additive. The first conductive additive may include Super P. The second conductive additive may include single-wall carbon nanotubes (SWCNT). In certain variations, a mass ratio of the silicon-containing electroactive material to the first conductive additive to the cross-linked polymer binder to the second conductive additive may be 80:10:9.8:0.2. The example electrode 410 may also include an electrolyte, like the electrolyte 30 illustrated in FIG. 1. For example, the example electrode 410 may include an electrolyte including 1 M lithium hexafluorophosphate (LiPF⁶) and co-solvents ethylene carbonate (EC) and dimethyl carbonate (DMC) and about 10 wt. % of fluoroethylene carbonate (FEC). The example electrode 410 may have a loading of about 1.45 mAh/cm².

A comparative electrode 420 may include the same silicon-containing electroactive material, the same one or more conductive additives, and the same electrolyte as the example electrode 410. However, the comparative electrode 420 may include lithiated polyacrylic acid (PAALi) as the polymeric binder instead of the cross-linked polymer binder including lithiated polyacrylic acid (PAALi) and poly(2-hydroxyethyl acrylate) (PHEA).

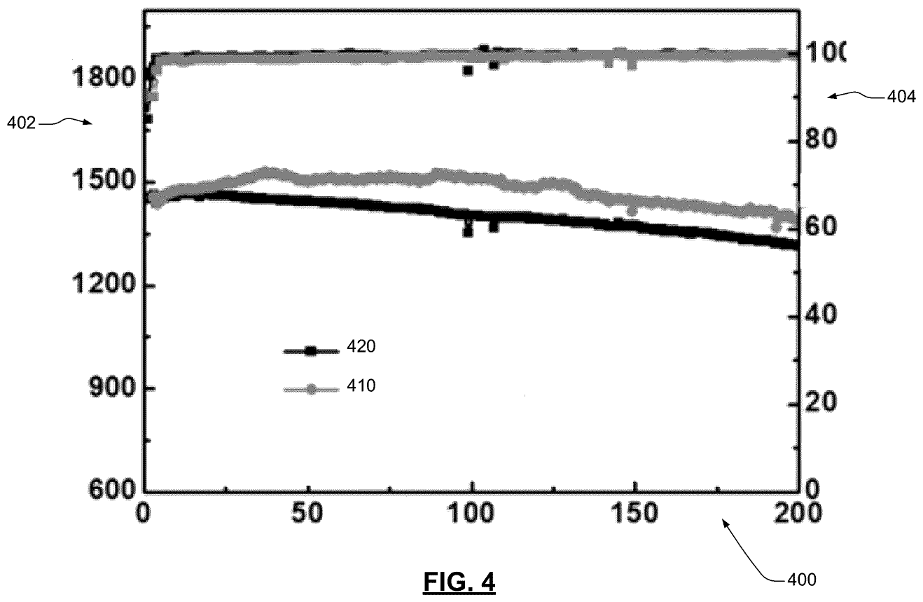

FIG. 4 is a graphical illustration demonstrating the capacity retention of the example electrode 410 after a 0.3 C cycle test, where the x-axis 400 represents cycle number, the y₁-axis 402 represents specific capacity (mAh·g⁻¹), and the y₂-axis 404 represents coulombic efficiency (%). As illustrated, the example electrode 410 has improved capacity retention as compared to the comparative electrode 420 after 200 cycles. For example, the example electrode 410 has a capacity retention of about 95% after 200 cycles, while the comparative electrode 420 has a capacity retention of about 90% after 200 cycles.

### Example 2

Example batteries and battery cells may be prepared in accordance with various aspects of the present disclosure. For example, an example electrode 510 may include cross-linked polymer binder including lithiated polyacrylic acid (PAALi) and poly(2-hydroxyethyl acrylate) (PHEA) in accordance with various aspects of the present disclosure. The example electrode 510 also includes a silicon-containing electroactive material including lithium doped silicon oxide (Li_{y}SiOₓ, where 0<y<1 and 0<x<2 (LSO) and a carbonaceous electroactive material including graphite. For example, the electroactive material may include about 20 wt. % of the silicon-containing electroactive material and about 80 wt. % of the carbonaceous electroactive material. The example electrode 510 may also include one or more conductive additives. For example, the example electrode 510 may include a first conductive additive and a second conductive additive. The first conductive additive may include Super P. The second conductive additive may include single-wall carbon nanotubes (SWCNT). In certain variations, a mass ratio of the silicon-containing electroactive material to the first conductive additive to the cross-linked polymer binder to the second conductive additive may be 80:10:9.8:0.2. The example electrode 510 may also include an electrolyte, like the electrolyte 30 illustrated in FIG. 1. For example, the example electrode 410 may include an electrolyte including 1 M lithium hexafluorophosphate (LiPF₆) and co-solvents ethylene carbonate (EC) and dimethyl carbonate (DMC) and about 3 wt. % of fluoroethylene carbonate (FEC) and about 2 wt. % of vinylene carbonate (VC). The example electrode 510 may have a loading of about 2 mAh/cm² and a current density of about 210 mA/g.

A comparative electrode 520 may include the same electroactive materials, the same one or more conductive additives, and the same electrolyte as the example electrode 510. However, the comparative electrode 520 may include polyacrylic acid (PAA) as the polymeric binder instead of the cross-linked polymer binder including lithiated polyacrylic acid (PAALi) and poly(2-hydroxyethyl acrylate) (PHEA).

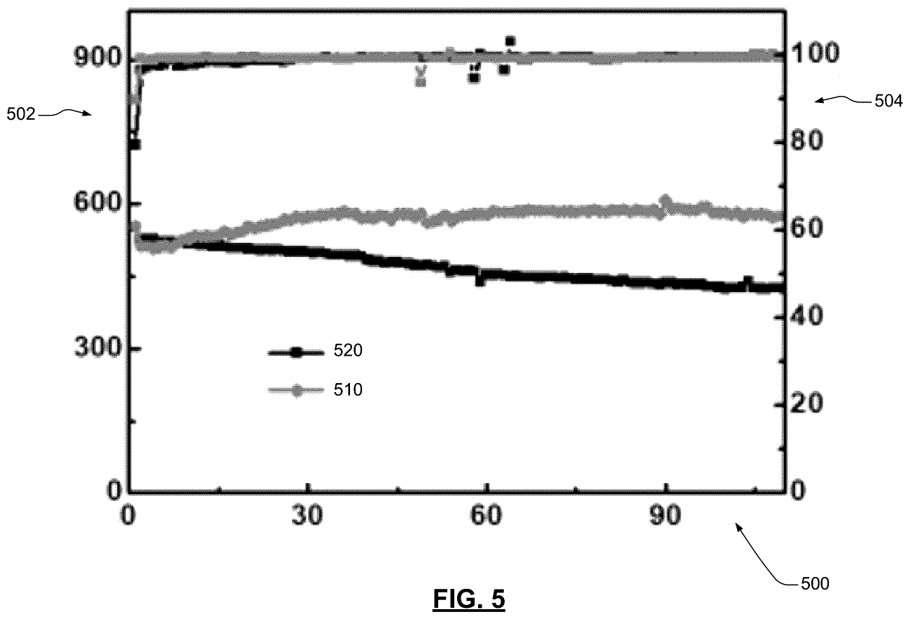

FIG. 5 is a graphical illustration demonstrating the capacity retention of the example electrode 510, where the x-axis 500 represents cycle number, the y₁-axis 502 represents specific capacity (mAh·g⁻¹), and the y₂-axis 504 represents coulombic efficiency (%). As illustrated, the example electrode 510 has improved capacity retention as compared to the comparative electrode 520 after 100 cycles. For example, the example electrode 510 has a capacity retention of about 95% after 200 cycles, while the comparative electrode 520 has a capacity retention of about 90% after 200 cycles.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrode for an electrochemical cell that cycles lithium ions, the electrode comprising:
a silicon-containing electroactive material; and
a polymeric network in contact with the silicon-containing electroactive material, the polymeric network comprising polyacrylic acid (PAA) cross-linked with poly(2-hydroxyethyl acrylate) (PHEA).

2. The electrode of claim 1, wherein the silicon-containing electroactive material comprises Li_{y}SiOₓ, where 0<y<1 and 0<x<2.

3. The electrode of claim 1, wherein the electrode further comprises a carbonaceous electroactive material.

4. The electrode of claim 3, wherein the electrode comprises greater than or equal to about 80 wt. % to less than or equal to about 98 wt. % of the silicon-containing electroactive material and greater than or equal to about 85 wt. % to less than or equal to about 95 wt. % of the carbonaceous electroactive material.

5. The electrode of claim 1, wherein the silicon-containing electroactive material comprises a plurality of silicon-containing electroactive material particles, and the polymeric network defines a plurality of polymeric cages, wherein each polymeric cage of the plurality of polymeric cages at least partially surrounds one or more silicon-containing electroactive material particles of the plurality of silicon-containing electroactive material particles.

6. The electrode of claim 1, wherein a mass ratio of the polyacrylic acid (PAA) to the poly(2-hydroxyethyl acrylate) (PHEA) is greater than or equal to about 0.5 to less than or equal to about 10.

7. The electrode of claim 1, wherein the electrode comprises greater than or equal to about 1 wt. % to less than or equal to about 15 wt. % of the polymeric network.

8. The electrode of claim 1, wherein the polyacrylic acid (PAA) is lithiated polyacrylic acid (PAALi).

9. The electrode of claim 1, wherein the electrode further comprises greater than or equal to about 0.5 wt. % to less than or equal to about 15 wt. % of a conductive additive.

10. The electrode of claim 1, wherein the polyacrylic acid (PAA) cross-linked with poly(2-hydroxyethyl acrylate) (PHEA) defines a first binder and the electrode further comprises greater than 0 wt. % to less than or equal to about 10 wt. % of a second polymeric binder.

11. The electrode of claim 10, wherein the second polymeric binder is selected from the group consisting of: polyimide (PI), polyamic acid, polyamide, polysulfone, polyvinylidene difluoride (PVdF), polytetrafluoroethylene (PTFE), polyhexafluoropropene, polychlorotrifluoroethylene, ethylene propylene diene monomer (EPDM) rubber, carboxymethyl cellulose (CMC), nitrile butadiene rubber (NBR), styrene-butadiene rubber (SBR), sodium alginate, lithium alginate, polyacrylonitrile (PAn), and combinations thereof.

12. An electrode for an electrochemical cell that cycles lithium ions, the electrode comprising:
a silicon-containing electroactive material comprising a plurality of silicon-containing electroactive material particles; and
a polymeric network forming polymeric cages around each of the silicon-containing electroactive material particles of the plurality, the polymeric cages comprising polyacrylic acid (PAA), lithiated polyacrylic acid (PAALi), or a combination of polyacrylic acid (PAA) and lithiated polyacrylic acid (PAALi) covalently bonded with poly(2-hydroxyethyl acrylate) (PHEA), and the polymeric network having a mass ratio of the polyacrylic acid (PAA), the lithiated polyacrylic acid (PAALi), or the combination of the polyacrylic acid (PAA) and the lithiated polyacrylic acid (PAALi) to the poly(2-hydroxyethyl acrylate) (PHEA) is greater than or equal to about 0.5 to less than or equal to about 10.

13. The electrode of claim 12, wherein the silicon-containing electroactive material comprises Li_{y}SiOₓ, where 0<y<1 and 0<x<2.

14. A method for preparing a silicon-containing electrode, the method comprising:
heating an electroactive material slurry disposed adjacent to one or more surfaces of a current collector to a temperature greater than or equal to about 120° ° C. to less than or equal to about 180° ° C. to form the silicon-containing electrode, wherein the electroactive material slurry comprises a plurality of silicon-containing electroactive material particles and polymeric binders comprising polyacrylic acid (PAA) and poly(2-hydroxyethyl acrylate) (PHEA), wherein after the heating, the silicon-containing electrode comprises a polymeric network that contacts each of the silicon-containing electroactive material particles of the plurality of silicon-containing electroactive material particles, the polymeric network comprising the polyacrylic acid (PAA) cross-linked with the poly(2-hydroxyethyl acrylate) (PHEA).

15. The method of claim 14, wherein the temperature is held for a period greater than or equal to about 30 minutes to less than or equal to about 5 hours.

16. The method of claim 14, wherein the temperature is a first temperature and the method further comprises preparing the poly(2-hydroxyethyl acrylate) (PHEA), wherein the preparing of the poly(2-hydroxyethyl acrylate) (PHEA) comprises:
contacting 2-hydroxyethyl acrylate (HEA) and an initiator to form an admixture;
heating the admixture to a second temperature greater than or equal to about 130° ° C. to less than or equal to about 180° C.; and
precipitating poly(2-hydroxyethyl acrylate) from the admixture.

17. The method of claim 14, wherein the method further comprises:
disposing the electroactive material slurry on the one or more surfaces of the current collector.

18. The method of claim 14, wherein the method further comprises:
preparing the electroactive material slurry by contacting the silicon-containing electroactive material, the polyacrylic acid (PAA), and the poly(2-hydroxyethyl acrylate) (PHEA).

19. The method of claim 14, wherein the polyacrylic acid (PAA) is lithiated polyacrylic acid (PAALi).

20. The method of claim 14, wherein the silicon-containing electroactive material comprises Li_{y}SiOₓ, where 0<y<1 and 0<x<2.
